(19) United States
(12) Patent Application Publication
(10) Pub. No.: US 2007/0108378 A1
(43) Pub. Date: May 17, 2007

(54) High pressure optical cell for a downhole optical fluid analyzer

(76) Inventors: Toru Terabayashi, Sagamihara-shi (JP); Tsuyoshi Yanase, Tokyo (JP)

Correspondence Address: SCHLUMBERGER K.K., 2-2-1 FUCHINOBE, SAGAMIHARA-SHI, KANAOAWA-KEN, 229-0006, JP

(21) Appl. No.: 11/274,732

(22) Filed: Nov. 14, 2005

(51) Int. Cl. G01V 8/00

(52) U.S. Cl. 250/256

(57) ABSTRACT

An apparatus for analyzing subterranean formation fluids includes a downhole tool, a fluid analysis module disposed in the downhole tool, a formation fluid flow path through the fluid analysis module, first and second cavities disposed in the fluid analysis module, and first and second windows disposed in first and second cavities of the fluid analysis module, respectively. The first and second windows each comprise a polished external sealing surface enabling high pressure fluid isolation.

### FIELD OF THE INVENTION

The present invention relates generally to subterranean formation evaluation and testing in the exploration and development of hydrocarbon-producing wells, such as oil or gas wells. More particularly, the invention relates to methods and apparatuses for producing high pressure optical cells for a downhole optical fluid analyzer used to analyze fluids produced in such wells.

### BACKGROUND OF THE INVENTION

In order to evaluate the nature of underground formations surrounding a borehole, it is often desirable to obtain and analyze samples of formation fluids from various specific locations in the borehole. Over the years, various tools and procedures have been developed to facilitate this formation fluid evaluation process. Examples of such tools can be found in U.S. Pat. No. 6,476,384 (“the '384 patent”), the entirety of which is hereby incorporated by reference.

As described in the '384 patent, Schlumberger's repeat formation tester (RFT) and modular formation dynamics tester (MDT) tools are specific examples of sampling tools. In particular, the MDT tool includes a fluid analysis module for analyzing fluids sampled by the tool. FIG. 1 illustrates a schematic diagram of such a downhole tool 10 for testing earth formations and analyzing the composition of fluids from the formation. Downhole tool 10 is suspended in a borehole 12 from a logging cable 15 that is connected in a conventional fashion to a surface system 18. Surface system 18 incorporates appropriate electronics and processing systems for control of downhole tool 10 and analysis of signals received from downhole tool 10.

Downhole tool 10 includes an elongated body 19, which encloses a downhole portion of a tool control system 16. Elongated body 19 also carries a selectively-extendible fluid admitting/withdrawal assembly 20 (shown and described, for example, in U.S. Pat. Nos. 3,780,575, 3,859,851, and 4,860,581, each of which is incorporated herein by reference) and a selectively-extendible anchoring member 21. Fluid admitting/withdrawal assembly 20 and anchoring member 21 are respectively arranged on opposite sides of elongated body 19. Fluid admitting/withdrawal assembly 20 is equipped for selectively sealing off or isolating portions of the wall of borehole 12, such that pressure or fluid communication with the adjacent earth formation is established. A fluid analysis module 25 is also included within elongated body 19, through which the obtained fluid flows. The obtained fluid may then be expelled through a port (not shown) back into borehole 12, or sent to one or more sample chambers 22, 23 for recovery at the surface. Control of fluid admitting/withdrawal assembly 20, fluid analysis module 25, and the flow path to sample chambers 22, 23 is maintained by electrical control systems 16, 18.

Over the years, various fluid analysis modules have been developed for use in connection with sampling tools, such as the MDT tool, in order to identify and characterize the samples of formation fluids drawn by the sampling tool. For example, U.S. Pat. No. 4,994,671 (incorporated herein by reference) describes an exemplary fluid analysis module that includes a testing chamber, a light source, a spectral detector, a database, and a processor. Fluids drawn from the formation into the testing chamber by a fluid admitting assembly are analyzed by directing light at the fluids, detecting the spectrum of the transmitted and/or backscattered light, and processing the information (based on information in the database relating to different spectra) in order to characterize the formation fluids. U.S. Pat. Nos. 5,167,149 and 5,201,220 (both of which are incorporated by reference herein) also describe reflecting light from a window/fluid flow interface at certain specific angles to determine the presence of gas in the fluid flow. In addition, as described in U.S. Pat. No. 5,331,156, by taking optical density (OD) measurements of the fluid stream at certain predetermined energies, oil and water fractions of a two-phase fluid stream may be quantified. As the techniques for measuring and characterizing formation fluids have become more advanced, the demand for more precise formation fluid analysis tools has increased.

As known in the art, the optical hardware employed in conventional fluid analysis modules may be adversely affected by the high pressures experienced in downhole environments. For example, optical windows interfacing with produced fluids are not capable of sealing against extremely high pressures. Consequently, fluids produced in some deep wells cannot be optically analyzed downhole. The electronics associated with optical fluid analysis must be fluidly isolated from the downhole conditions, and current windows are not capable of withstanding the high pressures found in certain wells.

Accordingly, there exists a need for an apparatus and method allowing optical fluid analysis in high pressure subterranean environments. More particularly, there is a need for high pressure optical cells capable of withstanding pressures up to 30 kpsi and more.

### SUMMARY OF THE INVENTION

The present invention provides a number of embodiments directed towards improving, or at least reducing, the effects of one or more of the above-identified problems. According to at least one embodiment, an apparatus for analyzing subterranean formation fluids comprising a downhole tool, a fluid analysis module disposed in the downhole tool, a formation fluid flow path through the fluid analysis module, first and second cavities disposed in the fluid analysis module, and first and second windows disposed in the first and second cavities of the fluid analysis module, respectively. The first and second windows each comprises a polished external sealing surface. In some embodiments, the polished external sealing surface comprises a specular polish such as a 0.15 a specular polish.

In certain embodiments, there is an O-ring seal and a backup seal disposed in an annulus between the cavities and windows. The backup seal may be a PEEK backup ring disposed in the cavities adjacent to each of the first and second windows. The first and second O-rings may be disposed around the polished external sealing surface of the first and second windows, respectively. The first and second windows each cooperate with their respective O-ring seals to hold pressures of 30 kpsi or more.

According to some embodiments, the windows comprise sapphire cylinders. In addition, some embodiments include first and second flanges enclosing the first and second windows, respectively. The first flange may comprise an input channel receptive of a first optical communication fiber, and the second flange may comprise an output channel receptive of a second optical communication fiber.

Some embodiments of the apparatus comprise a first internal flowline insert disposed in the formation fluid flow path. The first internal flowline insert holds the first and second windows, and the first internal flowline insert comprises a fluid channel interfacing the first and second windows.

Certain embodiments of the apparatus include a third window disposed in a third cavity spaced axially from the first and second cavities. The third window comprises an angular prism for gas detection. The third window includes a polished external sealing surface. The polished external sealing surface of the third window may comprise a specular polish such as a 0.15a specular polish. The apparatus may further comprise an O-ring and a PEEK back up seal ring disposed around the third window. The third window cooperates with the O-ring and PEEK back up seal ring to hold at least 30 kpsi. The apparatus may further comprise a second internal flowline insert disposed in the formation fluid flow path adjacent to the third window. The second internal flowline insert may comprise a generally V-shaped flow groove open toward the third window.

One embodiment of the apparatus includes a gas detector, the gas detector comprising the third window and the angular prism, an LED and lens adjacent to the angular prism, a monitor photodiode, and a detector array for detecting light from the LED reflected at an interface between the third window and fluids flowing through the second internal flowline. A fiber array plate may interface between the detector array and the angular prism.

In certain embodiments, the third window comprises a generally elongated circle portion adjacent to the angular prism portion. A third flange may enclose the third window.

Another embodiment provides an apparatus for analyzing subterranean formation fluids as well. The apparatus comprises a downhole tool, a fluid analysis module disposed in the downhole tool, the fluid analysis module comprising an optical cell spectrometer and a gas detection cell. The optical cell spectrometer comprises a formation fluid flow path through the fluid analysis module, first and second cavities disposed in the fluid analysis module, and first and second windows disposed in the first and second cavities of the fluid analysis module, respectively. The first and second windows each comprise a polished external sealing surface. The gas detection cell comprises a third window disposed in a third cavity spaced axially from the first and second cavities. The third window comprises an angular prism for gas detection. The third window also comprises a polished external sealing surface.

According to some embodiments, the polished external sealing surfaces of the first, second, and third windows comprise approximately a 0.15a specular polish. Further, the apparatus may include an O-ring seal and a PEEK backup seal disposed in the cavities adjacent to each of the first, second, and third windows. The O-ring seals and the PEEK backup seals of each of the first, second, and third windows are capable of isolating 30 kpsi of pressure.

Another aspect of the invention provides a method of making an apparatus for analyzing subterranean formation fluids. The method comprises providing a downhole tool, providing a fluid analysis module with a plurality of window cavities, polishing a plurality of windows to a specular polish, inserting the plurality of windows into the window cavities, and sealing the plurality of windows in the window cavities. Polishing may comprise polishing to a 0.15a specular polish. Sealing may comprise providing an O-ring for each of the plurality of windows, inserting the O-ring between each of the plurality of windows and each of the plurality of window cavities, and inserting a backup PEEK ring between each of the plurality of windows and each of the plurality of window cavities.

Features from any of the above-mentioned embodiments may be used in combination with one another in accordance with the present invention. These and other embodiments, features and advantages will be more fully understood upon reading the following detailed description in conjunction with the accompanying drawings and claims.

### BRIEF DESCRIPTION OF THE DRAWINGS

The accompanying drawings illustrate exemplary embodiments of the present invention and are a part of the specification. Together with the following description, the drawings demonstrate and explain the principles of the present invention.

FIG. 1 illustrates an exemplary downhole tool in which a fluid analysis cell according to principles of the present invention may be implemented.

FIG. 2 is an assembly diagram of an exemplary fluid analysis module for analyzing extracted samples of formation fluids according to one embodiment of the present invention.

FIG. 3 is a cross sectional view of a portion of the fluid analysis module of FIG. 2 illustrating the optical cell spectrometer.

FIG. 4A is a perspective view of an unpolished fluid analysis window.

FIG. 4B is a perspective view of a polished fluid analysis window according to one embodiment of the present invention.

FIG. 5A is a perspective view of an unpolished gas cell window.

FIG. 5B is a perspective view of a polished gas cell window according to one embodiment of the present invention.

FIG. 6 is a side cross-sectional view of the gas cell of FIG. 2 according to one embodiment of the present invention.

FIG. 7 is a top view of the fluid analysis module of FIG. 2 without the flanges in place.

FIG. 8 is a top view of a gas detection cell of the fluid analysis module of FIG. 2 without the flange in place.

FIG. 9 is a cross-sectional view, taken along line 9-9 of FIG. 7, of the fluid analysis module.

FIG. 10 is a cross-sectional view, taken along line 10-10 of FIG. 7, of the fluid analysis module.

FIG. 11 is a side view of the fluid analysis module of FIG. 2 with flanges in place over optical windows.

FIG. 12 is a top view of the fluid analysis module of FIG. 2 with flanges in place over optical windows.

Throughout the drawings, identical reference characters and descriptions indicate similar, but not necessarily identical elements. While the present invention is susceptible to various modifications and alternative forms, specific embodiments have been shown by way of example in the drawings and will be described in detail herein. However, one of skill in the art will understand that the present invention is not intended to be limited to the particular forms disclosed. Rather, the invention covers all modifications, equivalents and alternatives falling within the scope of the invention as defined by the appended claims.

### DETAILED DESCRIPTION OF EXEMPLARY EMBODIMENTS

Illustrative embodiments and aspects are described below. One of ordinary skill in the art having the benefit of this disclosure will appreciate that in the development of any such embodiment, numerous implementation-specific decisions must be made to achieve the developers' specific goals, such as compliance with system-related and business-related constraints, which will vary from one implementation to another. Although such a development effort might be complex and time-consuming, the same would nevertheless be a routine undertaking for those of ordinary skill in the art having the benefit of this disclosure.

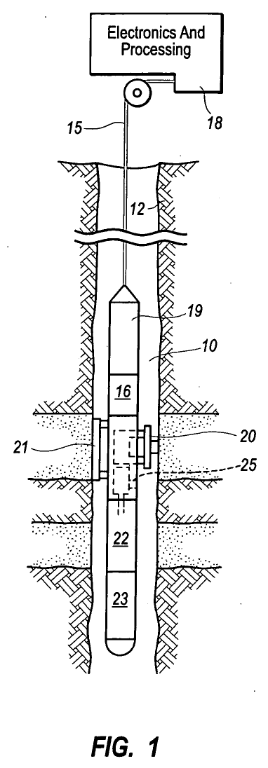

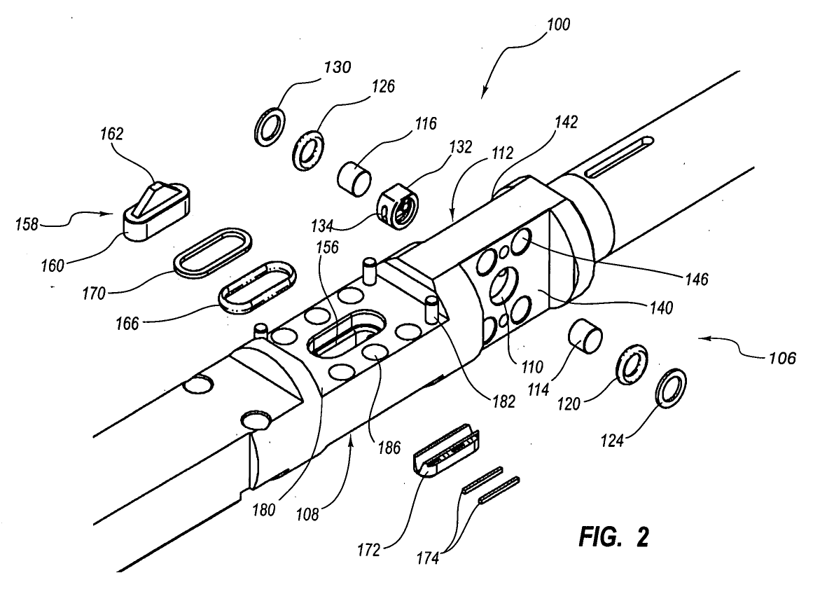

FIG. 2 is a partial assembly diagram of an exemplary fluid analysis module 100 for analyzing extracted samples of formation fluids. As will be appreciated by those of skill in the art, exemplary fluid analysis module 100 may be adapted for use in a variety of environments and/or included in a number of different tools. For example, fluid analysis module 100 may form a portion of a fluid analysis module 25 housed in downhole tool 10, as illustrated in FIG. 1. According to at least one embodiment, exemplary fluid analysis module 100 comprises a formation fluid flow path 102 (FIG. 3) housing an extracted formation fluid sample 104 (FIG. 3). Formation fluid sample 104 (FIG. 3) may be extracted, withdrawn, or admitted into flowline 102 (FIG. 3) in any number of ways known to those of skill in the art. For example, sample 104 (FIG. 3) may be admitted into flowline 102 (FIG. 3) by a fluid admitting/withdrawal assembly, such as fluid admitting/withdrawal assembly 20 illustrated in FIG. 1. As detailed above, fluid admitting/withdrawal assembly 20 may admit fluid samples by selectively sealing off or isolating portions of the wall of a borehole 12 (FIG. 1).

In certain embodiments, fluid analysis module 100 comprises an optical cell spectrometer section 106 and a gas detection section 108. The optical cell spectrometer section 106 is generally used for liquids analysis, and the gas detection section 108 is generally used to detect gas. The optical cell spectrometer section 106 includes a first cavity 110 and a second cavity 112 arranged opposite of the first cavity 110. The second cavity 112 may be coaxial and contiguous with the first cavity 110, and therefore the first and second cavities 110, 112 may comprise a single cavity through the optical cell spectrometer section 106 as shown in FIG. 2.

Each of the first and second cavities 110, 112 may be receptive of a window. For example, a first window 114 may be disposed in the first cavity 110, and a second window 116 may be disposed in the second cavity 112. The first and second windows 114, 116 may be substantially identical, and each may comprise a cylinder of optical grade sapphire or other optical grade material.

As mentioned in the background, windows in typical optical fluid analyzers are not capable of withstanding high pressures associated with some wells. In fact a standard window in a downhole optical fluid analyzer can withstand no more than 22 Kpsi. However, according one embodiment of the present invention, the first and second windows 114, 116 are polished and sealed within the cavities 110, 112, and are capable of isolating pressure differences of 30 to 33 kpsi or more.

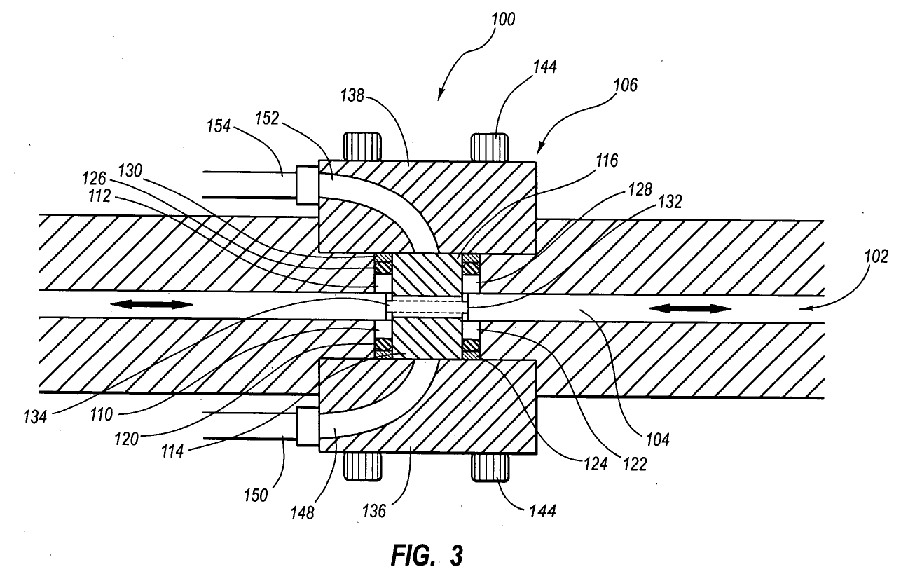

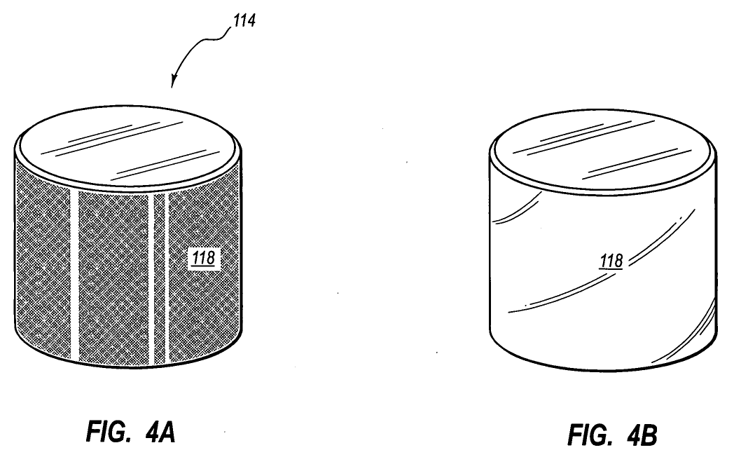

FIG. 4A illustrates the first window 114 with an unpolished external sealing surface 118. The unpolished sealing surface 118 of FIG. 4A may be incapable of cooperating with a seal to isolate pressure differences of 30 to 33 kpsi. However, as shown in FIG. 4B, the external sealing surface 118 of the first window 114 (and likewise the second window 116) is polished to a specular polish. For example, the external sealing surface 118 may comprise a 0.15a specular polish.

Returning to FIG. 2, the external sealing surface 118 (FIG. 4B) of the first and second windows 114, 116 may cooperate with one or more seals to facilitate pressure isolations of 30 to 33 Kpsi or more. For example, a first O-ring 120 may be disposed in an annulus 122 (FIG. 3) between the first cavity 110 and the first window 114. In addition to the first O-ring 120, the apparatus may include a first back up seal 124 in the annulus 122 (FIG. 3) between the first cavity 110 and the first window 114. The first back up seal 124 may comprise PEEK (polyetheretherkeytone), which resists deformation, even at very high pressures (including pressures of at least 30 kpsi).

Similarly, a second O-ring 126 may be disposed in an annulus 128 (FIG. 3) between the second cavity 112 and the second window 116. Again, in addition to the second O-ring 126, the apparatus may include a second back up seal 130 in the annulus 128 (FIG. 3) between the second cavity 112 and the second window 116. The second back up seal 130 also comprises PEEK (polyetheretherkeytone).

According to some embodiments, the first and second windows 114, 116 fit at least partially in a shell 132. The shell 132 slides in between the first and second cavities 110, 112, and may include a first internal flowline insert 134. The first internal flowline insert 134 reduces the flowthrough diameter of the flowline 102 (FIG. 3), and interfaces with each of the first and second windows 114, 116, presenting the sample 104 (FIG. 3) to the windows 114, 116 and allowing the passage of light through the windows 114, 116. The first internal flowline insert 134 is shown more clearly in cross-section in FIG. 10, which is described in more detail below.

As shown in FIG. 3, first and second flanges 136, 138 enclose the shell 132 and the first and second windows 114, 116 within the first and second cavities 110, 112. Mating first and second recesses 140, 142 (FIG. 2) in the optical cell spectrometer section 106 receive the first and second flanges 136, 138. A plurality of bolts, for example four bolts 144, may thread into mating threaded recesses 146 (FIG. 2) and attach the first and second flanges 136, 138 to the optical cell spectrometer section 106. The first and second windows 114, 116 may be flush with or recessed in the first and second cavities 110, 112, respectively, to maintain a gap between the first and second flanges 136, 138 and the respective windows 114, 116. Therefore, no matter how tightly the first and second flanges 136, 138 are fit to the optical cell spectrometer section 106, there is little or no mechanical pressure exerted on the windows 114, 116 by the flanges 136, 138.

The first flange 136 comprises an input channel 148 extending therethrough. The input channel 148 is receptive of a first optical communication fiber or fiber bundle 150. The input channel 148 may curve approximately ninety degrees and lead the first optical communication fiber 150 to a normal orientation with respect to the first window 114. Accordingly, the first optical communication fiber 150 may present a light source to the first window 114, and the first window may pass the light through the sample 104.

The second flange 138 comprises an output channel 152 extending therethrough. The output channel 152 is receptive of a second optical communication fiber or fiber bundle 154. The output channel 152 may curve approximately ninety degrees and lead the second optical communication fiber 154 to a normal orientation with respect to the second window 116. Accordingly, the second optical communication fiber 154 may collect light passing through the sample 104 and through the second window 116, and present the collected light to a spectrometer for analysis.

Light passed through the sample 104 via the first and second windows 114, 116 is primarily analyzed for liquid components. However, as shown in FIG. 2, the fluid analysis module 100 also includes the gas detection section 108. The gas detection section 108 comprises a third cavity 156. The third cavity 156 is receptive of another window. For example, a third window 158 may be disposed in the third cavity 156. The third windows 158 may comprise a generally elongated cylinder or circle 160 adjacent to an angular prism 162. The elongated cylinder 160 and the angular prism 162 may comprise a unitary piece of optical grade sapphire or other optical grade material. According to one embodiment of the present invention, the third window 158 is polished and sealed within the third cavity 156 and is capable of isolating pressure differences of 30 to 33 kpsi or more.

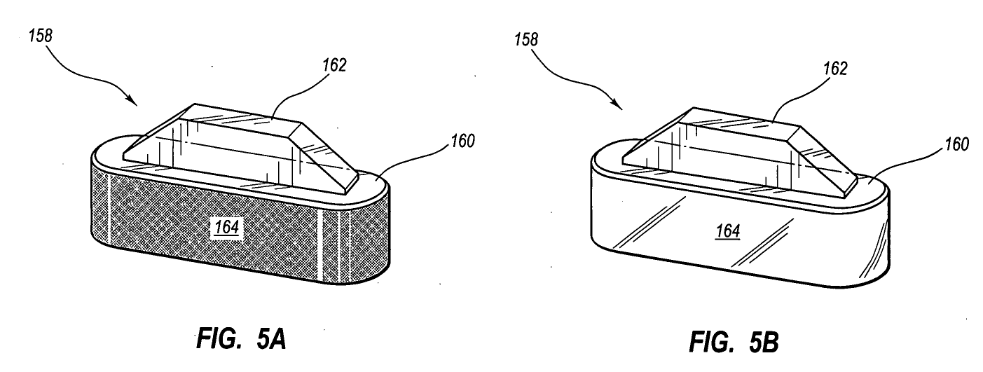

FIG. 5A illustrates the third window 158 with an unpolished external sealing surface 164. The unpolished sealing surface 164 of FIG. 5A may be incapable of cooperating with a seal to isolate pressure differences of 30 to 33 kpsi. However, as shown in FIG. 5B, the external sealing surface 164 of the third window 158 is polished to a specular polish. For example, the external sealing surface 164 may comprise a 0.15a specular polish.

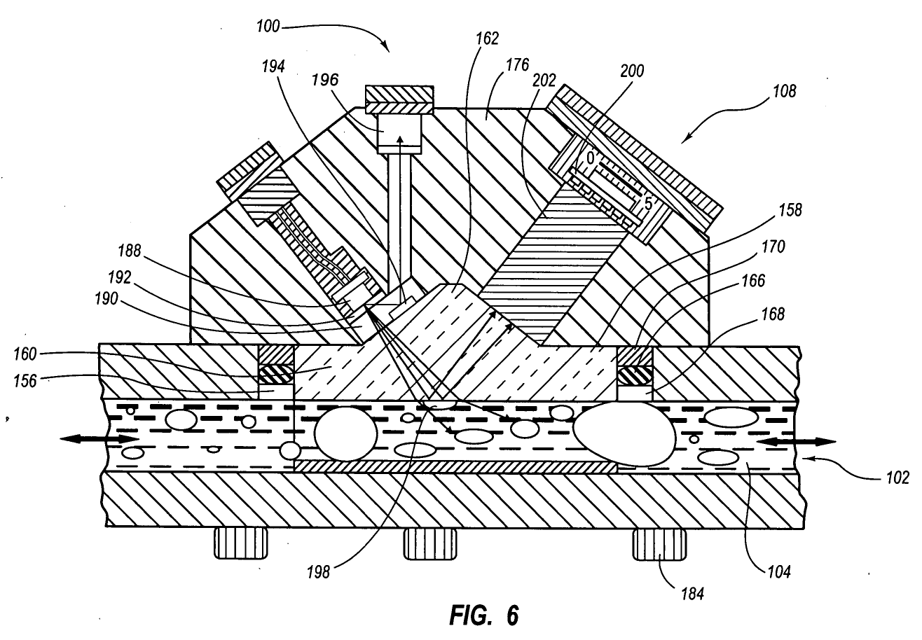

Returning to FIG. 2, the external sealing surface 164 (FIG. 5B) of the third window 158 may cooperate with one or more seals to facilitate pressure isolations of 30 to 33 Kpsi or more. For example, a third (elongated) O-ring 166 may be disposed in an annulus 168 (FIG. 6) between the third cavity 156 and the third window 158. Further, in addition to the third O-ring 166, the apparatus may include a third back up seal 170 in the annulus 168 (FIG. 6) between the third cavity 156 and the third window 158. The third back up seal 170 may comprise PEEK.

Referring to FIGS. 2 and 6, the third window 158 is arranged adjacent to a second internal flowline insert 172. The second internal flowline insert 172 reduces the flowthrough diameter of the flowline 102 and presents the sample 104 to the third window 158. The second internal flowline insert 172 is shown more clearly in cross-section in FIG. 9, which is described in more detail below. In addition, a pair of third window supports 174 may fit inside the third cavity 156 in between the second internal flowline insert 172 and third window 158 (see FIG. 9).

As shown in FIG. 6, a third flange 176 encloses the third window 158 within the third cavity 156 (FIG. 2). A mating third recess 180 (FIG. 2) in the gas detection section 108 receives the third flange 176. One or more pins 182 (FIG. 2) may ensure proper alignment of the third flange 176 with respect to the mating third recess 180 (FIG. 2). A plurality of bolts 184 may thread into mating threaded recesses 186 (FIG. 2) and attach the third flange 176 to the gas detection section 108.

The third flange 176 interfaces the third window 158 and may house a number of gas detection components known to those of ordinary skill in the art having the benefit of this disclosure. For example, as shown in FIG. 6, the gas detector structure may include a light source such as an LED 188 and a lens 190 adjacent to one surface of the angular prism 162. A polarizer 192 may be arranged between the LED 188 and the lens 190. A reflector 194, which is also arranged adjacent to the prism 162, may reflect a portion of the light emitted by the LED 188 to a reference or monitor photodiode 196. Light emitted by the LED 188 may also pass through the angular prism 162 and the elongated cylinder 160, where it tends to be reflected at a gas 198/third window 158 interface (if gas is present at the interface) and detected by a detector array 200. If the interface is adjacent to liquids, the angle of the angular prism 162 is such that the light tends to refract through the sample. A fiber array plate 202 may direct light reflected at the gas 198/third window 158 interface.

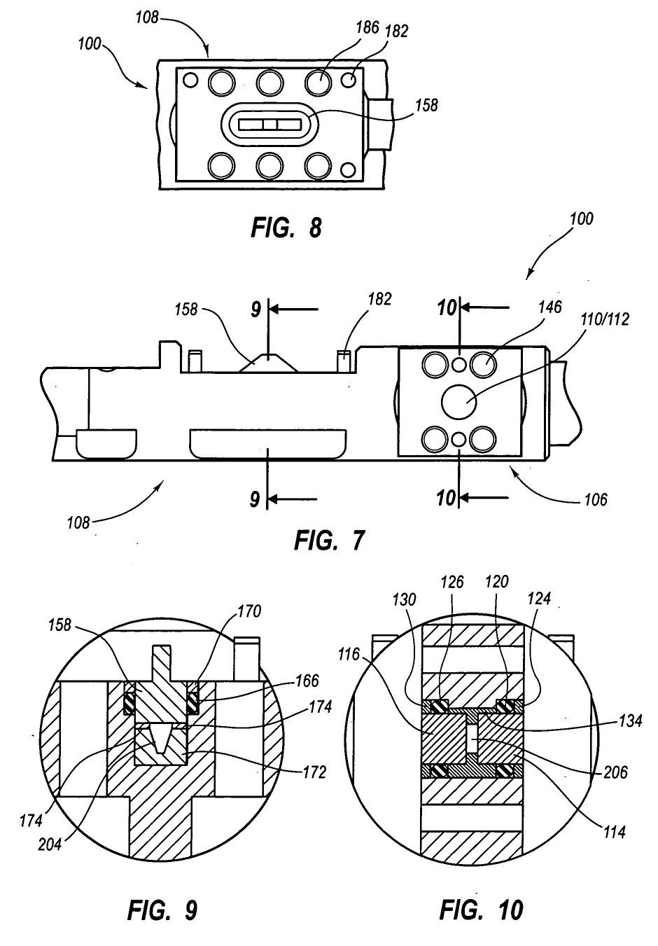

Referring next to FIGS. 7-10, the fluid analysis module 100 is shown without the flanges 136, 138, 176 (FIGS. 2 and 6) in a side (FIG. 7) view and a top view (FIG. 8, representing the gas detector section 108). Cross-sections along lines 9-9 and 10-10 of FIG. 7 illustrate the second and first internal flowline inserts 172, 134, respectively. As shown in FIG. 9, the second internal flowline insert 172 comprises a generally V-shaped channel or groove 204 open to the third window 158.

Similarly, as shown in FIG. 10, the first internal flowline insert 134 defines a sample path 206 that is generally rectangular and open to both of the first and second windows 114, 116. Therefore, light may be transmitted through the first window 114, through the sample contained by the sample path 206, and through the second window 116. Information related to the light transmitted through the sample is then relayed along the second optical communication fiber or fiber bundle 154 for processing and/or analysis.

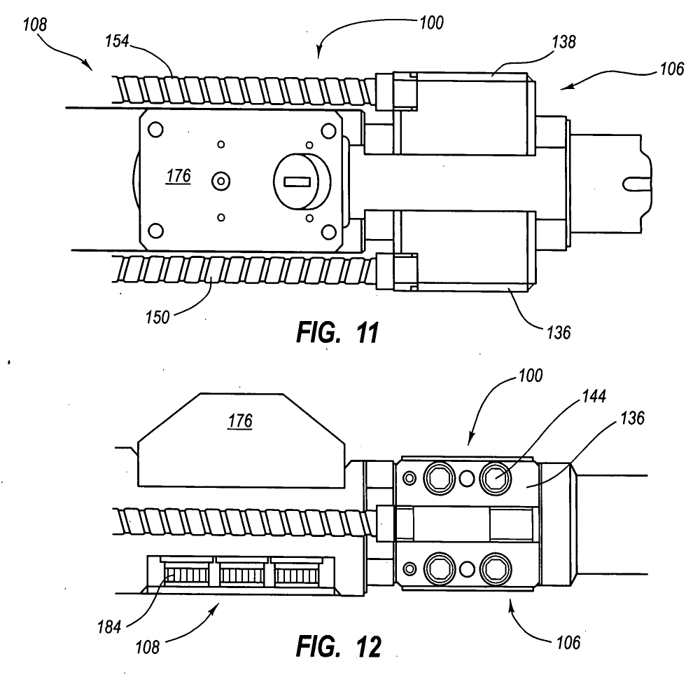

FIGS. 11-12 illustrate the fluid analysis module 100 from a side and top view, respectively, with the first, second, and third flanges 136, 138, 176 installed. The fluid analysis module 100 is fully assembled and ready for use. Moreover, the flanges cover the first, second, and third windows 114, 116, 158 (FIG. 2), which are arranged with seals sufficient to isolate the sample fluid 104 (FIG. 3) from any sensitive components at pressures of up to 30-33 kpsi or more.

The preceding description has been presented only to illustrate and describe the invention and some examples of its implementation. This exemplary description is not intended to be exhaustive or to limit the invention to any precise form disclosed. Many modifications and variations are possible in light of the above teaching. For example, one of ordinary skill in the art will appreciate that the principles, methods and apparatuses disclosed herein are applicable to many oilfield operations, including MWD, LWD, and wireline operations.

As used throughout the specification and claims, the terms “borehole” or “downhole” refer to a subterranean environment, particularly in a borehole. The words “including” and “having,” as used in the specification and claims, have the same meaning as the word “comprising.” The preceding description is also intended to enable others skilled in the art to best utilize the invention in various embodiments and aspects and with various modifications as are suited to the particular use contemplated. It is intended that the scope of the invention be defined by the following claims.

What is claimed is:

1. An apparatus for analyzing subterranean formation fluids, comprising:
a downhole tool;
a fluid analysis module disposed in the downhole tool;
a formation fluid flow path through the fluid analysis module;
first and second cavities disposed in the fluid analysis module;
first and second windows disposed in the first and second cavities of the fluid analysis module, respectively, the first and second windows each comprising a polished external sealing surface.

2. The apparatus of claim 1, wherein the polished external sealing surface comprises a specular polish.

3. The apparatus of claim 1, wherein the polished external sealing surface comprises approximately a 0.15a specular polish.

4. The apparatus of claim 1, further comprising an O-ring seal and a backup seal disposed in an annulus between the cavities and windows.

5. The apparatus of claim 1, further comprising an O-ring seal and a PEEK backup seal disposed in the cavities adjacent to each of the first and second windows.

6. The apparatus of claim 1, further comprising first and second O-rings disposed around the polished external sealing surface of the first and second windows, respectively.

7. The apparatus of claim 1, further comprising an O-ring seal and a PEEK backup seal disposed in the cavities adjacent to each of the first and second windows, wherein the first and second windows each cooperate with their respective O-ring seals to hold at least 30 kpsi.

8. The apparatus of claim 1, wherein the windows comprise sapphire cylinders.

9. The apparatus of claim 1, further comprising first and second flanges enclosing the first and second windows, respectively; the first flange comprising an input channel receptive of a first optical communication fiber and the second flange comprising an output channel receptive of a second optical communication fiber.

10. The apparatus of claim 1, further comprising a first internal flowline insert disposed in the formation fluid flow path and holding the first and second windows, the first internal flowline insert comprising a fluid channel interfacing the first and second windows.

11. The apparatus of claim 1, further comprising a third window disposed in a third cavity spaced axially from the first and second cavities; the third window comprising an angular prism for gas detection, the third window comprising a polished external sealing surface.

12. The apparatus of claim 11, wherein the polished external sealing surface of the third window comprises a specular polish.

13. The apparatus of claim 11, wherein the polished external sealing surface of the third window comprises approximately a 0.15a specular polish.

14. The apparatus of claim 11, further comprising an O-ring and a PEEK back up seal ring disposed around the third window.

15. The apparatus of claim 14, wherein the third window cooperates with the O-ring and PEEK back up seal ring to hold 30 kpsi.

16. The apparatus of claim 11, further comprising a second internal flowline insert disposed in the formation fluid flow path adjacent to the third window, the second internal flowline insert comprising a generally V-shaped flow groove open toward the third window.

17. The apparatus of claim 16, further comprising a gas detector, the gas detector comprising:
the third window and the angular prism;
an LED and lens adjacent to the angular prism;
a monitor photodiode;
a detector array for detecting light from the LED reflected at an interface between the third window and fluids flowing through the second internal flowline insert.

18. The apparatus of claim 17, further comprising a fiber array plate interfacing between the detector array and the angular prism.

19. The apparatus of claim 11, wherein the third window comprises a generally elongated circle portion adjacent to the angular prism portion.

20. The apparatus of claim 11, further comprising a third flange enclosing the third window.

21. An apparatus for analyzing subterranean formation fluids, comprising:
a downhole tool;
a fluid analysis module disposed in the downhole tool, the fluid analysis module comprising an optical cell spectrometer and a gas detection cell;
wherein the optical cell spectrometer comprises:
a formation fluid flow path through the fluid analysis module;
first and second cavities disposed in the fluid analysis module;
first and second windows disposed in first and second cavities of the fluid analysis module, respectively, the first and second windows each comprising a polished external sealing surface;
wherein the gas detection cell comprises:
a third window disposed in a third cavity spaced axially from the first and second cavities; the third window comprising an angular prism for gas detection, the third window comprising a polished external sealing surface.

22. The apparatus of claim 21, wherein the polished external sealing surfaces of the first, second, and third windows comprise approximately a 0.15a specular polish.

23. The apparatus of claim 22, further comprising an O-ring seal and a PEEK backup seal disposed in the cavities adjacent to each of the first, second, and third windows.

24. The apparatus of claim 23, wherein the O-ring seals and the PEEK back up seals of each of the first, second, and third windows are capable of isolating 30 kpsi of pressure.

25. A method of making an apparatus for analyzing subterranean formation fluids, comprising:
providing a downhole tool;
providing a fluid analysis module with a plurality of window cavities;
polishing a plurality of windows to a specular polish;
inserting the plurality of windows into the window cavities;
sealing the plurality of windows in the window cavities.

26. The method of claim 25, wherein the polishing comprises polishing to a 0.15a specular polish.

27. The method of claim 25, wherein the sealing comprises:
inserting an O-ring between each of the plurality of windows and each of the plurality of window cavities;
inserting a backup PEEK ring between each of the plurality of windows and each of the plurality of window cavities.
